(19) United States
(12) Patent Application Publication
(10) Pub. No.: US 2002/0144276 A1
(43) Pub. Date: Oct. 3, 2002

(54) Method for streamed data delivery over a communications network

(76) Inventors: Jim Radford, Pasadena, CA (US); David Alexander Boyd, South Pasadena, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/823,451

(22) Filed: Mar. 30, 2001

(51) Int. Cl. H04N 7/173

(52) U.S. Cl. 725/87; 725/109

(57) ABSTRACT

The invention provides a system and methods for the delivery of streamed content over a network. The system and methods of the invention are suited for the delivery of streaming video content over a network at a variety of data rates. The system allows a user to dynamically select the quality level of data to be delivered while a video is being displayed. Moreover, the system also can automatically select content suitable for a client device's connection speed as well as hardware, software, network and firewall configurations.

### FIELD OF THE INVENTION

The invention relates to a system for controlling the delivery of streamed video data over a communications network.

### BACKGROUND

Increasingly, networks such as the Internet and corporate intranets are being used for the delivery of streamed data content (e.g., streaming of audio and video files). A number of factors can affect the speed with which an end user or client can connect to a server through a network such as the Internet. Such factors include the geographic proximity of a user to a server, traffic on the network, and the number of connections or subnetworks over which the information being transferred must pass. In providing content over the Internet, the bottleneck for the majority of users is their connection speed to an Internet service provider (ISP). While connection speeds are steadily increasing, a majority of users connect to the Internet using dial-up connections over phone lines. These connections typically have maximum connection speeds on the order of 56 kbit/sec (kbps). Actual connection speeds are often significantly lower, as a result of line noise and congestion at the ISP.

Typical residential data transfer rates for standard Internet connections range from about 14 kbps to about 500 kbps. For comparison, broadcast quality television requires bandwidths of 1-6 Mbps. Providing streamed video at this rate using current network infrastructure is not feasible in terms of cost or bandwidth available to end users. While available bandwidth and network conditions are large factors in the quality of video delivered, local factors related to the user are also critical to delivery of streaming audio and video files and must be considered. These local factors such as hardware, local network settings, software configuration and compatibility are critical to the user's experience. Limited hardware capability and unoptimized systems can inhibit a satisfactory experience even with a high bandwidth network connection. For example, firewalls are often employed by organizations to block streaming audio and video protocols from user. Although these firewalls can be breeched with appropriate user configurations, setting the appropriate configuration may require a high degree of technical knowledge. Finally, as players and compression scheme are continually updated, it is possible that a client does not have the appropriate player or plug-in. When a user has a player, it is often the case that the player is not properly installed or configured. Again, installation of a player can pose problems for a user with limited technical knowledge, including the bulk of Internet users.

At low connection speeds, the display of streaming video is often erratic; the video display can be jerky, and the associated audio track, which typically requires far less bandwidth, also can be interrupted. For companies providing video content over a network, there is a great need to provide the highest quality data that is available for a user's connection speed.

Moreover, the broad range in connection speeds available to Internet users requires a content provider either to choose to deliver content at a data rate suitable only for the lowest average connection speed or to provide content capable of being displayed at a variety of connection speeds. A solution to the problem of delivering streaming content suitable for different connection speeds has been to provide initial multiple choices to a user, where the user or client has to choose the speed of their connection. However, many users are not aware of their connection speed. Even sophisticated users may be unaware of their actual connection speed when connecting through a corporate intranet, as there could be issues with a firewall and or player configurations. Further, once the session has begun, the user cannot dynamically adjust the stream quality that he is receiving, and at best, the stream must start over. Systems that automatically adjust the quality in response to changes in available bandwidth are not optimized over all bandwidth ranges and cannot allow dynamic switching of the image size or allow a user to switch to a slide show, audio only, or other display mode.

Because of these and other problems with delivering streaming content over a computer network, there exists a need for an improved system capable of providing streamed data to users in a format appropriate to the user's connection speed and that allows a user to actively control the quality of video being delivered.

### SUMMARY

The invention provides a system and methods for the selection and reception of information over a communications network. In one aspect of the invention, a system is provided that delivers streaming video content to a client device over a communications network.

In one aspect, the invention provides a method for the delivery of streamed data content from a server to a client device over a communications network. According to the method, streamed data content is requested from a listing server and an initial streamed data content file is delivered to the client device from one or more hosting servers. The hosting serves have a plurality of streamed data content files stored therein. The plurality of content files can be stored independently or the plurality of content files stored on the hosting server can be stored as a single file and converted to the appropriate quality level in response to said requesting. The initial streamed data content file is displayed to the client device. According to the method, a user interface program is implemented and a user interface is displayed on the client device. The program allows the user of the client device to adjust the quality level of the streamed content being displayed. The quality level can be changed over a wide range of quality levels, including data transfer or bit rates, formats (e.g., audio vs. slideshow vs. video), and image sizes. The user interface program can be stored on the host device or can be downloaded to the client device from a server.

After display of the initial streamed data content, a user can adjust the quality level of the content being displayed by re-requesting from the listing server or hosting server or servers, a second streamed data content file having a different quality level from the initial streamed content file. The second streamed data content file corresponds to substantially the same information content as the initially requested data content, but encoded, produced or stored at a different quality level. A user's re-request includes an initiation time pointer corresponding to a position within the initial streamed data file being displayed at the time of said re-request. A second data content file is then delivered to the client device from a position determined relative to the time pointer. The second data content file is preferably delivered from a position that is less than about 10 seconds from the initial time pointer, more preferably less than about 5 seconds from the initial time pointer and even more preferably less than about one second from the initial time pointer.

According to the methods of the invention, the network protocols available on a client device also can be determined and can be determined by the user interface program. The protocol can be, for example, UDP, RTP, RTSP or RSVP.

According to the methods of the invention, the connection speed of the client device to the listing server or to the hosting or hosting servers can be determined. The connection speed can be determined prior to delivery of the initial streamed content. The connection speed can be determined from a value stored on a client device, for example, a user-defined value, or can be determined by connection speed determining program. In speed determining program implemented on the client device. In one embodiment, the connection speed is determined by the user interface program. When the connection speed has been determined for a connection of the client device to the communications, the initial streamed data content can be to have a quality level appropriate for the determined connection speed. For example, when the connection speed is between about 8 kilobits per second and about 20 kilobits per second, the initial streamed data content is delivered as a slide show. When the connection speed is greater than about 20 kilobits per second, the initial streamed data content is delivered as a video.

Also provided is a system for controlling the display of streamed data content, having a client device, a hosting server or servers, having a plurality of data content files stored therein and a user interface program, wherein the program allows a user of the client device to adjust the quality level of the streamed content being displayed, the user interface program having a data content display region and a quality level interface, wherein a user action at the quality level interface results in the display of the video content without the necessity of restarting streaming of the content from the beginning of the content file. The user interface can be a graphical user interface program displayed on the client device. The graphical user interface can use any suitable means for interacting.

### BRIEF DESCRIPTION OF THE DRAWINGS

FIG. 1 provides a schematic illustration of a method of selecting media content for delivery.

FIG. 2 schematically illustrates a graphical interface suitable for use with the invention.

### DETAILED DESCRIPTION

Throughout this description, the preferred embodiment and examples shown should be considered as exemplars, rather than as limitations on the present invention.

The invention provides a system and methods for the delivery of streamed data over a communications network to a client device. Client devices are any devices capable of recording or displaying streamed digital data. Suitable client devices include, for example, mobile telephones, personal digital assistants (PDAs), computers, display terminals, digital televisions, and the like. A client device can be connected to the network both through a wired connection (both optical and electronic) or wirelessly.

The streamed data to be delivered includes multimedia content, including for example, video content or audio-video content. “Streamed data” as used herein refers to any content that can be listened to, viewed or otherwise observed by a user without having to download the content in its entirety. In a preferred embodiment, the system is designed to deliver streamed video content to a client device. According to the invention, the quality level of the data streamed to the client device from a hosting server can be matched to a connection speed of the client device. The connection speed can be an actual connection speed or can correspond to a preset or default connection speed. Quality level as used herein encompasses the bitrate of data transferred. Higher quality can support a faster frame rate, for example, or, in the case of video content can support a higher bitrate and/or a larger image size or resolution. According to the invention, the quality level of the streamed data provided to the client device can be altered by a user of the client device, without reinitiating content delivery from the beginning of the content file.

In a method of the invention, a client device connects to a listing server over a communications network, for example over the Internet. A request 110 is made by the client device for content to a listing server for streaming audio/video content. In such an embodiment, the user can request the streaming content through a single action, for example, clicking on a hyperlink (e.g., a button on a web page), by a keystroke, or through a voice command, or through multiple actions, for example, selection followed by a confirmation. It is generally preferred that the user only need perform a single action to initiate streaming content delivery. In response to the user's request, an initial streamed data file is transferred over the communications network to the client device from a hosting server or servers. The hosting server or servers can be the same server or server as the listing servers, or can be a different server.

The initial quality level of the streamed data provided to the user can be fixed by the content provider, can be selected by the user from a number of options, or can be determined automatically. In one embodiment, the initial quality level is determined by a user's preset data transfer preference, that can be, for example, set by the user. In another embodiment, the connection speed of the client is determined by a computer program running on either the client device or on the listing or hosting server. In a preferred embodiment, the client's connection speed to the network (x) is determined 120 by a computer program running on either the client or on the listing server.

When the computer program to determine the client device connection speed to the network is run on the client device, the program can be run from software installed on the client device. For example, when utilizing a browser software package such as MICROSOFT INTERNET EXPLORER™ or NETSCAPE NAVIGATOR™ the computer program can be executed as a plug-in component of the browser software. The computer program also can be downloaded to the client device in response to the user request for content. In such cases, it is preferable that the program downloaded to the client computer is appropriate for the operating system being used on the client device. In a preferred embodiment, the computer program is implemented in a substantially platform-independent programming language. Suitable platform independent languages include, for example, Javascript and Java, as they can be interpreted directly by most currently available browsers without user intervention.

The computer program installed on the client device can determine the connection speed of the client device to the network in a variety of methods. As used herein, the “connection speed” can refer to an actual connection speed, including an instantaneous connection speed and a time-averaged connection speed, or can refer to a user-defined connection speed. In response to the request for streaming content, the connection speed of the user is determined. A client-defined connection speed can be provided by a user, for example, during the installation of a multimedia player program, or can be configured by software on the client device. A multimedia player program, for example, during installation can query a user regarding the user's anticipated connection speed. In the case of software operating in a networked environment, a network administrator can set an appropriate value during installation of the computer system. A multimedia player program also can determine the connection speed based on the hardware connection being used (for example, use of a dial-up modem, a cable modem or Ethernet connection). A connection speed can be determined using the Synchronized Multimedia Integration Language (SMIL) standards. Synchronized Multimedia Integration Language (SMIL) for example in the W3C 1.0 Specification (http://www.w3.org/TR/1998/REC-smil-19980615). The SMIL language provides for the Boolean test attribute “system-bitrate.” The standard allows this attribute to be used in an application defined standard. The SMIL language is supported by a variety of media player programs and plug-in programs such as REALPLAYER™. The system-bitrate command returns a value of “true” if the connection speed is greater than or equal to the argument of the expression.

A client device can have multiple ways of connecting to a communications network. For example, a notebook computer can be used within an office environment through a high-speed Ethernet connection, but also can have a dial-up modem for use outside the office. In such a case, a client device can have more than one user- or application-defined connection speed. In such cases, a connection speed also can be determined by the client from a table of predicted connection speeds for particular types of network connection. In another embodiment, the connection speed can be determined from average connection speeds achieved through a given connection type.

In a preferred embodiment, a client device's connection speed to the network is initially determined using a using a computer program running on the client device. The program is implemented using Javascript. The Javascript returns an initial value for approximate download speed and the appropriate encoded file is selected for delivery from the hosting server to the client device.

The methods of the invention can determine appropriate quality levels for delivery to a client device for a variety of connection speeds. The methods of the invention can use a variety of threshold values (e.g., y, q and z) or value ranges for determining the appropriate level of content to serve 130, 135 and 136. Appropriate content quality levels can be expressed in a variety of ways, for example, as data stream rates that require less than the threshold connection speed to display correctly. Of course, the connection speed necessary to display a given video image at a certain frame rate will depend on the size of the frame to be displayed. In the embodiments described below, frame rates are given corresponding to a 100 by 100 pixel image. Using these figures as a guide, one of skill in the art could determine that for a given connection speed and encoding scheme, a 50 by 50 image could be supported at 4 times the data transfer rate. The data transfer rate that can be supported at a given connection speed also will depend on the amount of encoding provided in compression of the video signal, such as those incorporated in REAL PLAYER™ and MICROSOFT MEDIA PLAYER™.

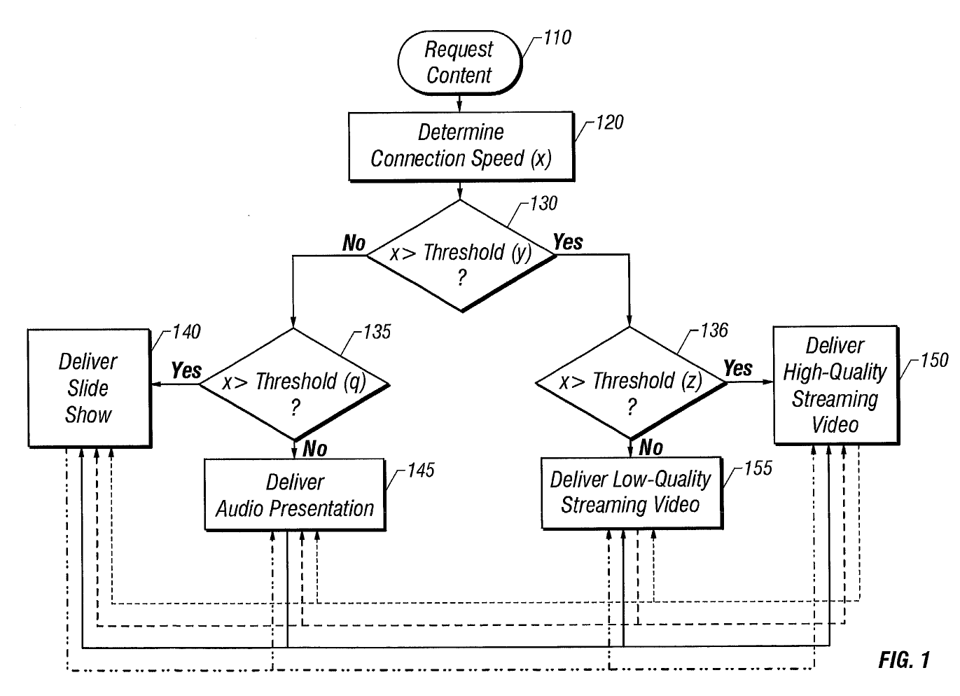

In a preferred embodiment, content is classified into multiple quality levels: for example, very low (e.g., audio only), low (e.g., slide show), medium and high. The methods of the invention can be used with more quality levels or with fewer quality levels. In the example shown in FIG. 1, three threshold values y, q, and z are used to select content quality appropriate for connection speed (x). If the connection speed is lower than threshold y and greater than threshold q, the data is delivered as a low quality slide show 140. If the connection speed is less than threshold q, the data is delivered as an audio file 145. If the connection speed is greater than threshold z and threshold y, then content is delivered as a high-quality streaming video file 150. If the connection speed is less than threshold z, but greater than threshold y, then the data is provided as a low-quality streaming video file 155.

Prior to streaming data content to the client device, the available network protocols on the client device can be determined. For example, a program running on the client device can determine an appropriate file format to be used with a supported viewer on the client device. The program can be the same program as the connection speed determining program or can be a different program. Suitable file transfer protocols include Real-Time Streaming Protocol (RTSP), Real-Time Protocol (RTP), Real-Time Control Protocol (RTCP), Resource Reservation Source Protocol (RSVP), and the User Datagram Protocol (UDP).

In one embodiment, the program running on the client device determines if the RTSP protocol is allowed. Local factors may prevent either RTSP or UDP protocols or the multimedia players may not be configured properly. Selection of the appropriate network protocol allows content delivery to a user without a user having to select from a list of potentially confusing or conflicting choices. Such an approach also allows a content provider to utilize state-of-the-art protocols and viewers without abandoning users with older systems, protocols and viewers. Once the available bandwidth and appropriate network protocol is determined, the appropriate content format is selected for the user. Importantly, determining the available protocols available for a client device allows delivery without a user needing to identify the proper type of file to select. From the view of a client provider, such a system allows can favor a preferred network protocol, for example, on that provides the best quality for a given data transfer rate.

Streaming data files having a variety of quality levels are stored on the hosting server or servers. Content files representing the same overall information content can be stored on the hosting server or servers. For example, a 30 second television commercial could be encoded at 56 kbps, at 112 kbps and at 256 kbps. The same overall information content also can be stored as a slide show file, having, for example, 7 images displayed with a sound track. Likewise, the television commercial could be encoded as an audio only file. The overall information content also can be delivered in a completely different format. The files can be implemented for a variety of multimedia decoders and viewers including, for example, the REALPLAYER™, MICROSOFT MEDIA PLAYER™, QUICKTIME™, and MACROMEDIA FLASH PLAYER™. A file has a time signature that allows a user to select a starting point within a larger streamed file. The network protocols for which a file was generated will determine the format of the time signature.

Initial content is then delivered to the client device and displayed to the user. A user interface also is provided. The user interface is displayed to the user along with the content being displayed. The user interface can be implemented on the client device or can be implemented on a server and displayed to the client device. The user interface allows a user to dynamically change the quality level of streamed data received during display of the streamed data. For example, if the network or ISP becomes congested and the quality of the streamed data deteriorates or is marred by interruptions (typically such interruptions are required to cache the streaming data), a user might wish to switch to a lower quality level (i.e., one requiring less bandwidth). The interface can be any suitable interface, including voice activated, graphical, text-based, or any other suitable interface for providing input to a client device. The user can interact with the interface with any suitable input device including, for example, a microphone, a mouse, a trackball, a keyboard or other keypad device, a touch screen, a tablet, an eye-tracking device and any other suitable device known to one of skill in the art. When the user interface is graphical, the interface can be integrated within a browser window, can appear in a separate window, can appear in a pull-down menu, a toolbar, and the like. The user interface can user any means of interacting, including for example, dials, knobs, slide, buttons, text links, and the like.

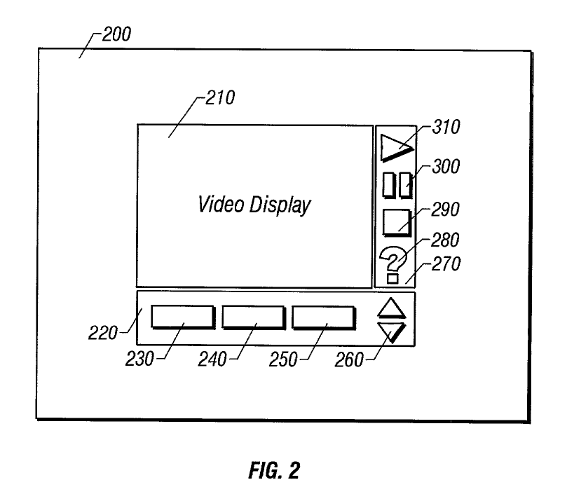

An example of a suitable graphical user interface, the Video Quality Management System (VQMS), is shown schematically in FIG. 2. A window 200 is displayed on the client device. The window includes a display area 210. The interface also includes a quality control region 220, having buttons for selecting an appropriate quality level 230-250, and image size buttons 260 for adjusting the size of the video display area. The VQMS interface also has a streaming video control region 270 having various video controls including buttons for play 310, pause 300, stop 290 and for help 280.

The user interface allows a user to adjust the quality level of the streamed data being provided from the hosting server or servers. The interface can indicate only the quality levels available (corresponding to files located on the hosting server or servers) or can provide a simple increase/decrease quality functionality. When the streamed data is video data, the interface also can allow the user to specifically adjust the quality level by choosing to change the image size, resolution, or bit rate of the streamed data. In response to an action by the user through the user interface, a second request (or re-request) is generated to the listing server, or to the hosting server directly, for the initiation of delivery of a new file to the client device. The request carries a time stamp or pointer, such that the new data is streamed starting from a position relative to the approximate point when the user selected a desire to change the quality level. In a preferred embodiment, the pointer corresponds to the time position of the streamed data that is being displayed at the time that the user's re-request is initiated. In one embodiment, the system caches the new streamed data while continuing to play the initial streamed data, so that the transition from the initial streamed data to the new streamed data occurs without restarting the video. In another embodiment, the new streamed data is requested to start a few seconds earlier than the point at which the user re-request was made. When quality has deteriorated, this allows for the rebroadcast of a short segment of the data stream. A user's re-request for a change in quality level can result also in a change of network protocol and of the associated decoder/viewer software. For example, a streaming video that is not displaying well may be better displayed as a slide show file. A slide show file can be encoded using a more efficient different file format, such as the MACROMEDIA FLASH™ file format rather than in a streaming video format.

The hosting server or servers can store a plurality of content files at varying quality levels corresponding to a set of information to be transferred. Each information set has associated with it individual files encoded over a range of distinctive bitrates and video image sizes, each of which is suitable for a particular bandwidth range. A significant advantage to hosting a plurality of files at differing quality levels is that each quality level can be optimized for performance and appearance. For example, rather than random selection of frames to be displayed for a slide show from those in a streaming video file, a slide show can be constructed that focuses only on key images. Such an embodiment is useful in the case of very low available bit rates but high resolution, large size images. Likewise, at extremely low connection speeds, content can be provided in a more efficient format, such as a MACROMEDIA FLASH format.

In one embodiment, the various quality level files are stored in a single nested file. The hosting server also can generate content files at an appropriate quality level from a single quality level “master file” of higher quality on-the-fly in response to the user request. To improve the quality of the data displayed in a slide show format, the invention provides for the tagging of individual frames within the master file as “slide-show frames”. Rather than selecting frames from within the sequence of a streaming audio-video file either sequentially (e.g., every 20^{th} frame) or randomly, the system allows for the selection of the most appropriate frames for display as a slide show. A master file can contain several subsets of tagged slide show frames, where the tags indicate the quality level at which the frames should be shown.

In delivering the content to the user, a system of the invention can invoke a multimedia player program. Examples of suitable player programs include the REALPLAYER™ and the MICROSOFT MEDIA PLAYER™. Such programs can run as freestanding applications, or can run as HTML standard plug-ins.

A number of embodiments of the present invention have been described. Nevertheless, it will be understood that various modifications may be made without departing from the spirit and scope of the invention. For example, where specific values (e.g., for data transfer rates) are given, other values generally can substituted in known fashion. Accordingly, it is to be understood that the invention is not to be limited by the specific illustrated embodiment, but only by the scope of the appended claims.

What is claimed is:

1. A method for the delivery of streamed data content from a server to a client device over a communications network, the method comprising:
requesting a streamed data content from a listing server;
delivering to a client device an initial streamed data content file from one or more hosting servers having a plurality of streamed data content files stored therein;
displaying the initial streamed data content to the client device;
implementing a user interface program, wherein the program has a user interface displayed on the client device and wherein the program allows a user of the client device to adjust the quality level of the streamed content being displayed.

2. The method of claim 1, further comprising delivering the user interface program to the client device.

3. The method of claim 1, further comprising:
re-requesting from the listing server or hosting server a second streamed data content file having a different quality level from said initial streamed content file, wherein said re-requesting includes an initiation time pointer corresponding to a position within the initial streamed data file being displayed at the time of said re-requesting;
delivering said second data content file to the client device from a position relative to the initiation time pointer.

3. The method of claim 3, wherein the position is less than about 10 seconds from the initial time pointer.

4. The method of claim 4, wherein the position is less than about 5 seconds from the initial time pointer.

5. The method of claim 4, wherein the position is less than about 1 second from the initial time pointer.

6. The method of claim 3, wherein said program is substantially platform independent.

7. The method of claim 6, wherein said program is implemented in Java or Javascript.

8. The method of claim 3, wherein the initial streamed data content file is a video file.

9. The method of claim 8, wherein the different quality level is a different image size.

10. The method of claim 8, wherein the different quality level is a different data transfer rate.

11. The method of claim 1, further comprising determining an available network protocol on the client device.

12. The method of claim 11, wherein said protocol determining is accomplished by the user interface program implemented on the client device.

13. The method of claim 12, wherein the protocol to be determined is selected from the group consisting of UDP, RTP, RTSP and RSVP.

14. The method of claim 1, further comprising determining a connection speed of the client device to the listing server or to the hosting or hosting servers prior to delivering the initial streamed content.

15. The method of claim 14, wherein the connection speed is determined by reading a user-defined value for a client device.

16. The method of claim 14, wherein the value is determined using a connection speed determining program implemented on the client device.

17. The method of claim 16, wherein the connection speed determining program is the user interface program.

18. The method of claim 14, further comprising selecting the initial streamed data content to have a quality level appropriate for the determined connection speed.

19. The method of claim 18, wherein the initial streamed data content is delivered as a slide show when the connection speed is between about 8 kilobits per second and about 20 kilobits per second.

20. The method of claim 18, wherein the initial streamed data content is delivered as a video when the connection speed is greater than about 20 kilobits per second.

21. The method of claim 1, wherein the plurality of content files are stored on the hosting server as a single file and converted to the appropriate quality level in response to said requesting.

22. A method for the delivery of streamed data content from a server to a client device over a communications network, the method comprising:
requesting a streamed data content from a listing server;
determining a connection speed of the client device to a hosting server;
determining an available network protocol on a client device;
delivering to the client device an initial streamed data content file from one or more hosting servers having a plurality of streamed data content files stored therein;
displaying the initial streamed data content to the client device;
implementing a user interface program on the client device, wherein the program allows a user of the client device to adjust the quality level of the streamed content being displayed.

23. A system for controlling the display of streamed data content, the system comprising:
a client device;
a hosting server or servers, having a plurality of data content files stored therein;
a user interface program, wherein the program allows a user of the client device to streamed content being displayed, the user interface program comprising:
a data content display region;
a quality level interface, wherein a user action at the quality level interface results in the display of the video content without the necessity of restarting streaming of the content from the beginning of the content file.

24. The system of claim 23, wherein the user interface is a graphical user interface program displayed on a video display device.

25. The system of claim 24, wherein quality level interface comprises one or more means for interacting.
